(19) United States
(12) Patent Application Publication
(10) Pub. No.: US 2023/0271518 A1
(43) Pub. Date: Aug. 31, 2023

(54) POWER SUPPLY CIRCUIT OF AIRCRAFT

(71) Applicant: HONDA MOTOR CO., LTD., Tokyo (JP)

(72) Inventors: Manabu Mitani, Wako-shi (JP); Sadao Shinohara, Wako-shi (JP); Masataka Yoshida, Wako-shi (JP)

(21) Appl. No.: 18/173,977

(22) Filed: Feb. 24, 2023

(30) Foreign Application Priority Data
Feb. 28, 2022 (JP) 2022-028776

(51) Int. Cl. B60L 53/20; B64D 27/24; B60L 50/60

(52) U.S. Cl. CPC B60L 53/20; B64D 27/24; B60L 50/60; B64D 2221/00; B60L 2200/10; B64C 29/0008

(57) ABSTRACT

A power supply circuit of an aircraft includes: a first power transmission path and a second power transmission path each configured to supply electric power from power generation units to one or more drive modules; and a third power transmission path configured to supply electric power from a charging device to the first power transmission path. When one or more batteries are charged with the electric power supplied from the charging device, the electric power is supplied from the charging device to the batteries via the first power transmission path, and the electric power is supplied from the charging device to the batteries via the second power transmission path.

### CROSS-REFERENCE TO RELATED APPLICATIONS

This application is based upon and claims the benefit of priority from Japanese Patent Application No. 2022-028776 filed on Feb. 28, 2022, the contents of which are incorporated herein by reference.

### BACKGROUND OF THE INVENTION

### Field of the Invention

The present invention relates to a power supply circuit of an aircraft.

### Description of the Related Art

US 2019/0260216 A1 discloses an electric aircraft that is charged by an externally provided charging device. The electric aircraft includes a plurality of batteries. The charging device supplies power to each of the plurality of batteries via a power transmission bus provided in common to the batteries.

### SUMMARY OF THE INVENTION

In the electric aircraft disclosed in US 2019/0260216 A1, propulsors are driven by electric power supplied from the plurality of batteries. Therefore, each of the plurality of batteries has a large capacity. In order to charge each battery in a short period of time, a large current flows through the power transmission bus during charging. As a result, the amount of heat generated in the power transmission bus increases, and the temperature of the power transmission bus increases. When the temperature of the power transmission bus becomes too high, the power transmission bus may fail. Therefore, the power transmission bus is cooled by a cooling device during charging. As a result, there arises a problem in that power consumption of the cooling device increases as the current flowing through the power transmission bus increases.

An object of the present invention is to solve the above-mentioned problem.

According to an aspect of the present invention, there is provided a power supply circuit of an aircraft, the power supply circuit comprising: a first power transmission path configured to supply electric power to at least one load device; a second power transmission path provided in parallel with the first power transmission path, and configured to supply electric power to the at least one load device; and a third power transmission path connected to the first power transmission path, and configured to supply electric power from a charging device provided outside the aircraft to the first power transmission path, wherein at least one battery is connected to both the first power transmission path and the second power transmission path, and when the at least one battery is charged with the electric power supplied from the charging device, the electric power is supplied from the charging device to the battery via the first power transmission path, and the electric power is supplied from the charging device to the battery via the second power transmission path.

The present invention makes it possible to reduce the amount of heat generation in the power supply circuit of the aircraft.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of an aircraft;

FIG. 2 is a schematic diagram showing a configuration of a power supply system;

FIG. 3 is a control block diagram of the power supply system;

FIG. 4 is a schematic diagram of the power supply system;

FIG. 5 is a schematic diagram of the power supply system;

FIG. 6 is a schematic diagram of the power supply system;

FIG. 7 is a schematic diagram of the power supply system;

FIG. 8 is a schematic diagram of the power supply system;

FIG. 9 is a schematic diagram of the power supply system;

and

FIG. 10 is a schematic diagram of the power supply system.

### DETAILED DESCRIPTION OF THE INVENTION

### First Embodiment

### [Configuration of Aircraft]

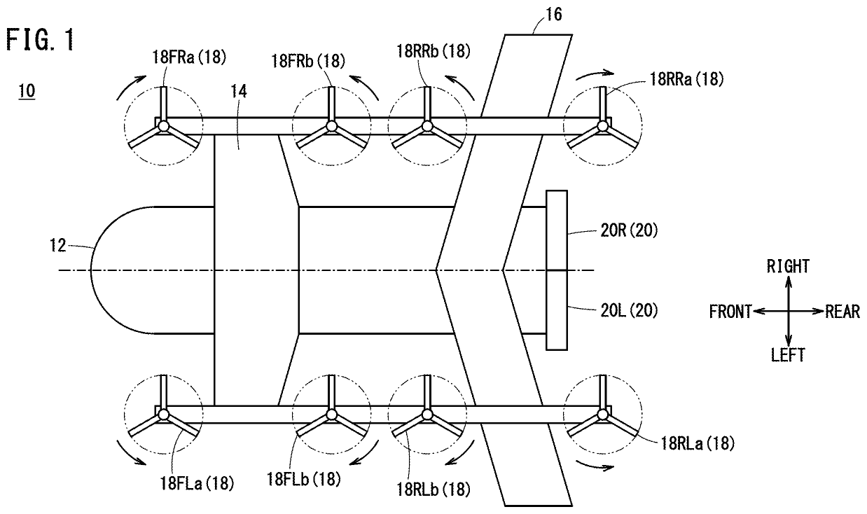

FIG. 1 is a schematic diagram of an aircraft 10. The aircraft 10 of the present embodiment is an electric vertical take-off and landing aircraft (eVTOL aircraft). In the aircraft 10, rotors are driven by electric motors. The aircraft 10 generates vertical thrust and horizontal thrust by the rotors. Further, the aircraft 10 is a hybrid aircraft. The aircraft 10 includes a generator and a battery as power sources of the electric motor. In the aircraft 10, electric power generated by the generator is supplied to the electric motor. When the electric power generated by the generator is insufficient with respect to the required electric power, the electric power stored in the battery is supplied to the electric motor.

The aircraft 10 includes a fuselage 12. The fuselage 12 is provided with a cockpit, a cabin, and the like. A pilot rides in the cockpit and controls the aircraft 10. Passengers and the like ride in the cabin. The aircraft 10 may be automatically controlled.

The aircraft 10 includes a front wing 14 and a rear wing 16. When the aircraft 10 moves forward, lift is generated in each of the front wing 14 and the rear wing 16.

The aircraft 10 includes eight VTOL rotors 18. The eight VTOL rotors 18 are a rotor 18FLa, a rotor 18FLb, a rotor 18RLa, a rotor 18RLb, a rotor 18FRa, a rotor 18FRb, a rotor 18RRa, and a rotor 18RRb.

The rotation shaft of each VTOL rotor 18 extends in the up-down direction. The thrust of each VTOL rotor 18 is controlled by adjusting the rotational speed of the rotor, the pitch angle of the blades, and the like. Each VTOL rotor 18 is used during vertical take-off, during transition from vertical take-off to cruising, during transition from cruising to vertical landing, during vertical landing, during hovering, and the like. Further, each VTOL rotor 18 is used during attitude control. The rotation shaft of each VTOL rotor 18 may be angled (canted) a few degrees with respect to the up-down direction.

Lift thrust is generated by controlling the thrust of each VTOL rotor 18. The lift thrust indicates thrust in the vertical direction. The thrust of each VTOL rotor 18 is controlled to cause a roll moment, a pitch moment, and a yaw moment to act on the fuselage 12.

The aircraft 10 includes two cruise rotors 20. The two cruise rotors 20 are a rotor 20L and a rotor 20R. The rotor 20L and the rotor 20R are attached to the rear portion of the fuselage 12.

The rotation shaft of each cruise rotor 20 extends in the front-rear direction. The thrust of each cruise rotor 20 is controlled by adjusting the rotational speed of the rotor, the pitch angle of the blades, and the like. Each cruise rotor 20 is used during transition from vertical take-off to cruising, during cruising, during transition from cruising to vertical landing, and the like. The rotation shaft of each cruise rotor 20 may be angled (canted) a few degrees with respect to the front-rear direction.

Cruise thrust is generated by controlling the thrust of each cruise rotor 20. The cruise thrust indicates thrust in the horizontal direction.

### [Configuration of Power Supply System]

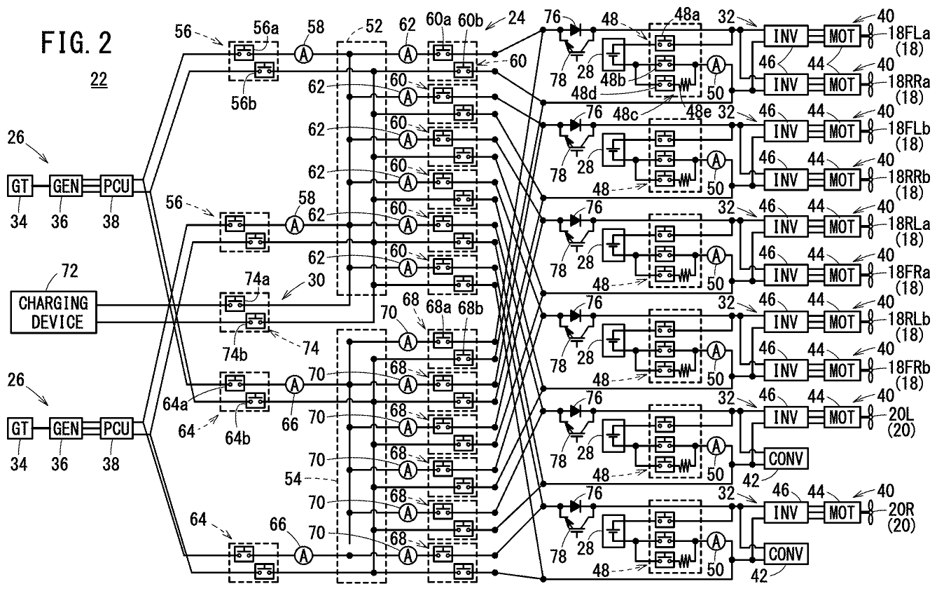

FIG. 2 is a schematic diagram showing a configuration of a power supply system 22. The power supply system 22 includes a power supply circuit 24, two power generation units 26, and six batteries 28.

The power supply circuit 24 supplies electric power from each of the two power generation units 26 to each of six drive modules 32. Electric power stored in each battery 28 is supplied to each drive module 32 separately from electric power generated by each power generation unit 26. Instead of the battery 28, a capacitor may be used.

Each power generation unit 26 includes a gas turbine 34, a generator 36, and a power control unit (hereinafter referred to as PCU) 38. The gas turbine 34 drives the generator 36. As a result, the generator 36 generates electric power. The PCU 38 converts the AC power generated by the generator 36 into DC power and outputs the DC power to the power supply circuit 24. In other words, the PCU 38 functions as an AC-DC converter. Each power generation unit 26 corresponds to a power source device of the present invention.

When the gas turbine 34 is started, the PCU 38 converts the DC power supplied from the power supply circuit 24 into AC power, and outputs the AC power to the generator 36. The generator 36 is operated by the electric power input from the PCU 38, and the generator 36 drives the gas turbine 34.

Among the six drive modules 32, four drive modules 32 each include two drive units 40. The other two drive modules 32 each include one drive unit 40 and one converter 42. Each VTOL rotor 18 or each cruise rotor 20 is driven by the drive unit 40.

Each drive unit 40 includes an electric motor 44 and an inverter 46. The electric motor 44 is a three phase motor. Each VTOL rotor 18 is coupled to the output shaft of each electric motor 44. Each cruise rotor 20 is coupled to the output shaft of each electric motor 44. The inverter 46 converts the DC power supplied from the power supply circuit 24 into three phase AC power, and outputs the three phase AC power to the electric motor 44.

The converter 42 steps down the voltage of the DC power supplied from the power supply circuit 24 and outputs the stepped-down power to a device operated by DC power. The device operated by DC power is, for example, a cooling device that cools the power supply circuit 24, the PCU 38, the inverter 46, and the like. The device operated by DC power is, for example, an electronic control unit (ECU) that controls the power supply circuit 24, the gas turbine 34, the PCU 38, the inverter 46, and the like.

The battery 28 is connected to each drive module 32. A contactor unit 48 is provided between each battery 28 and each drive module 32. Each contactor unit 48 includes a contactor 48a, a contactor 48b, and a precharge circuit 48c. The contactor 48a is provided on a positive line that connects each battery 28 and each drive module 32. The contactor 48b is provided on a negative line that connects each battery 28 and each drive module 32. The precharge circuit 48c is provided in parallel with the contactor 48b. The precharge circuit 48c includes a contactor 48d and a resistor 48e. A current sensor 50 is provided on the negative line that connects each battery 28 and each drive module 32.

Each contactor unit 48 switches between a conduction state and an interruption state, between each battery 28 and each drive module 32. The conduction state is a state in which the flow of current is not interrupted by the contactor unit 48, and thus the current flows. The interruption state is a state in which the flow of the current is interrupted by the contactor unit 48.

Each contactor unit 48 may include only the contactor 48b and the precharge circuit 48c. The precharge circuit 48c may be provided in parallel with the contactor 48a. In this case, each contactor unit 48 may include only the contactor 48a and the precharge circuit 48c.

The power supply circuit 24 includes a first power transmission path 52 and a second power transmission path 54. The first power transmission path 52 is configured to supply electric power from each power generation unit 26 to each drive module 32. The second power transmission path 54 is configured to supply electric power from each power generation unit 26 to each drive module 32.

The power supply circuit 24 includes two contactor units 56. Each contactor unit 56 is provided between each power generation unit 26 and the first power transmission path 52. Each contactor unit 56 includes a contactor 56a and a contactor 56b. Each contactor 56a is provided on a positive line that connects each power generation unit 26 and the first power transmission path 52. Each contactor 56b is provided on a negative line that connects each power generation unit 26 and the first power transmission path 52. A current sensor 58 is provided between each contactor 56a and the first power transmission path 52.

Each contactor unit 56 switches between the conduction state and the interruption state, between each power generation unit 26 and the first power transmission path 52. Each contactor unit 56 may include only one of the contactor 56a or the contactor 56b.

The power supply circuit 24 includes six contactor units 60. Each contactor unit 60 is provided between each drive module 32 and the first power transmission path 52. Each contactor unit 60 includes a contactor 60a and a contactor 60b. Each contactor 60a is provided on a positive line that connects each drive module 32 and the first power transmission path 52. Each contactor 60b is provided on a negative line that connects each drive module 32 and the first power transmission path 52. A current sensor 62 is provided between each contactor 60a and the first power transmission path 52.

Each contactor unit 60 switches between the conduction state and the interruption state, between each drive module 32 and the first power transmission path 52. Each contactor unit 60 may include only one of the contactor 60a or the contactor 60b. When each contactor unit 56 includes only the contactor 56a, the contactor unit 60 preferably includes only the contactor 60b. On the other hand, when each contactor unit 56 includes only the contactor 56b, the contactor unit 60 preferably includes only the contactor 60a.

The power supply circuit 24 includes two contactor units 64. Each contactor unit 64 is provided between each power generation unit 26 and the second power transmission path 54. Each contactor unit 64 includes a contactor 64a and a contactor 64b. Each contactor 64a is provided on a positive line that connects each power generation unit 26 and the second power transmission path 54. Each contactor 64b is provided on a negative line that connects each power generation unit 26 and the second power transmission path 54. A current sensor 66 is provided between each contactor 64a and the second power transmission path 54.

Each contactor unit 64 switches between the conduction state and the interruption state, between each power generation unit 26 and the second power transmission path 54. Each contactor unit 64 may include only one of the contactor 64a or the contactor 64b.

The power supply circuit 24 includes six contactor units 68. Each contactor unit 68 is provided between each drive module 32 and the second power transmission path 54. Each contactor unit 68 includes a contactor 68a and a contactor 68b. Each contactor 68a is provided on a positive line that connects each drive module 32 and the second power transmission path 54. Each contactor 68b is provided on a negative line that connects each drive module 32 and the second power transmission path 54. A current sensor 70 is provided between each contactor 68a and the second power transmission path 54.

Each contactor unit 68 switches between the conduction state and the interruption state, between each drive module 32 and the second power transmission path 54. Each contactor unit 68 may include only one of the contactor 68a or the contactor 68b. When each contactor unit 64 includes only the contactor 64a, each contactor unit 68 preferably includes only the contactor 68b. On the other hand, when each contactor unit 64 includes only the contactor 64b, each contactor unit 68 preferably includes only the contactor 68a.

The power supply circuit 24 includes a charging circuit 30. The charging circuit 30 is connected to the first power transmission path 52. A charging device 72 is connected to the charging circuit 30. The charging device 72 is installed outside the aircraft 10, such as on an apron, hangar, or the like. When the aircraft 10 is parked on the ground, the charging device 72 is connected to the charging circuit 30. The charging circuit 30 corresponds to a third power transmission path of the present invention.

The charging circuit 30 includes a contactor unit 74. The contactor unit 74 is provided between the charging device 72 and the first power transmission path 52. The contactor unit 74 includes a contactor 74a and a contactor 74b. The contactor 74a is provided on a positive line that connects the charging device 72 and the first power transmission path 52. The contactor 74b is provided on a negative line that connects the charging device 72 and the first power transmission path 52.

The contactor unit 74 switches between the conduction state and the interruption state, between the charging device 72 and the first power transmission path 52. The contactor unit 74 may include only one of the contactor 74a or the contactor 74b.

A diode 76 is provided between each battery 28 and a contact point connected to both the first power transmission path 52 and the second power transmission path 54. Each diode 76 is provided on a positive line that connects each battery 28 and the contact point. An anode of each diode 76 is connected to the contact point, and a cathode thereof is connected to each battery 28. The diode 76 allows electric power to be supplied from the first power transmission path 52 and the second power transmission path 54 to each battery 28. The diode 76 prevents electric power from being supplied from each battery 28 to the first power transmission path 52 and the second power transmission path 54.

Thus, electric power is supplied from the power generation unit 26 to each battery 28 via each diode 76. Further, electric power is supplied from the charging device 72 to each battery 28 via each diode 76. As a result, each battery 28 is charged. In addition, when the first power transmission path 52 is short-circuited or when the second power transmission path 54 is short-circuited, the electric power of each battery 28 is prevented from flowing to the first power transmission path 52 or the second power transmission path 54. As a result, even when the first power transmission path 52 is short-circuited or the second power transmission path 54 is short-circuited, electric power can be supplied from each battery 28 to the drive unit 40 and the converter 42 in each drive module 32.

A transistor 78 is provided in parallel with each diode 76. When the transistor 78 is ON, electric power is supplied from each battery 28 to the first power transmission path 52 and the second power transmission path 54 while bypassing the diode 76.

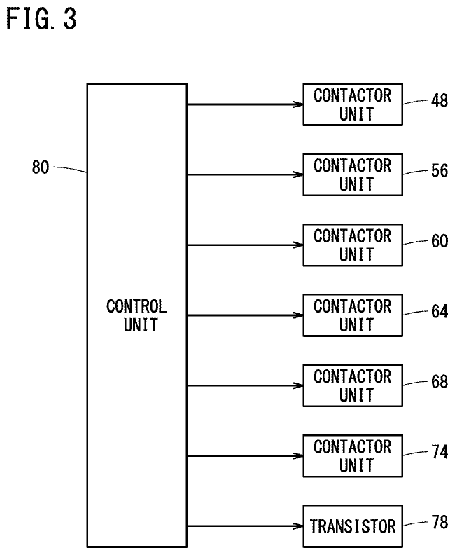

FIG. 3 is a control block diagram of the power supply system 22. The power supply system 22 includes a control unit 80. The control unit 80 controls the contactor units 48, the contactor units 56, the contactor units 60, the contactor units 64, the contactor units 68, the contactor unit 74, and the transistors 78.

The control unit 80 is realized by processing circuitry. The processing circuitry can be configured by an integrated circuit such as an application specific integrated circuit (ASIC) or a field-programmable gate array (FPGA). Further, the processing circuitry may be configured by an electronic circuit including a discrete device. The processing circuitry may be configured by a processor such as a central processing unit (CPU) or a graphics processing unit (GPU). In this case, the processing circuitry is realized by the processor executing programs stored in a storage unit (not shown).

[Operation of Contactor Unit]

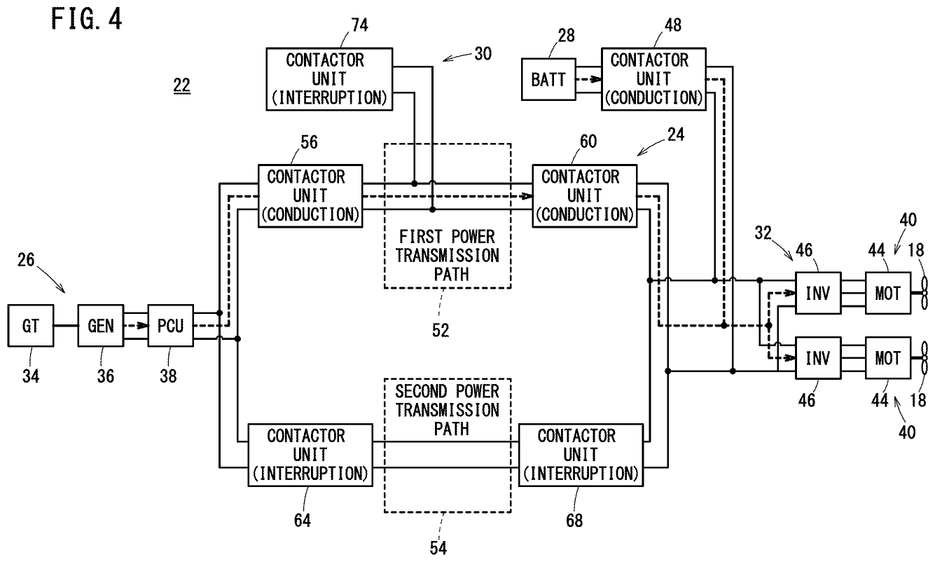

FIGS. 4 to 6 are schematic diagrams of the power supply system 22. FIGS. 4 to 6 schematically show the circuit configuration of the power supply circuit 24 between one power generation unit 26 and one drive module 32. Hereinafter, the operation of each contactor unit will be described with reference to FIGS. 4 to 6. In the case where the number of the power generation units 26 is two or more and the number of the drive modules 32 is two or more, although the number of the contactor units is increased, the operation of each contactor unit is the same as the operation described below.

(Case where Electric Motor is Operated)

When the electric motor 44 is operated, the control unit 80 brings each of the contactor unit 48, the contactor unit 56, and the contactor unit 60 into the conduction state as shown in FIG. 4. Further, the control unit 80 brings each of the contactor unit 64, the contactor unit 68, and the contactor unit 74 into the interruption state. In this case, the charging device 72 is not connected to the charging circuit 30.

As a result, electric power is supplied from the generator 36 to each electric motor 44 via the first power transmission path 52. Further, electric power is supplied from the battery 28 to each electric motor 44. Each electric motor 44 is operated by the electric power supplied from the generator 36 and the battery 28, and each electric motor 44 drives each VTOL rotor 18.

(Case where First Power Transmission Path Fails)

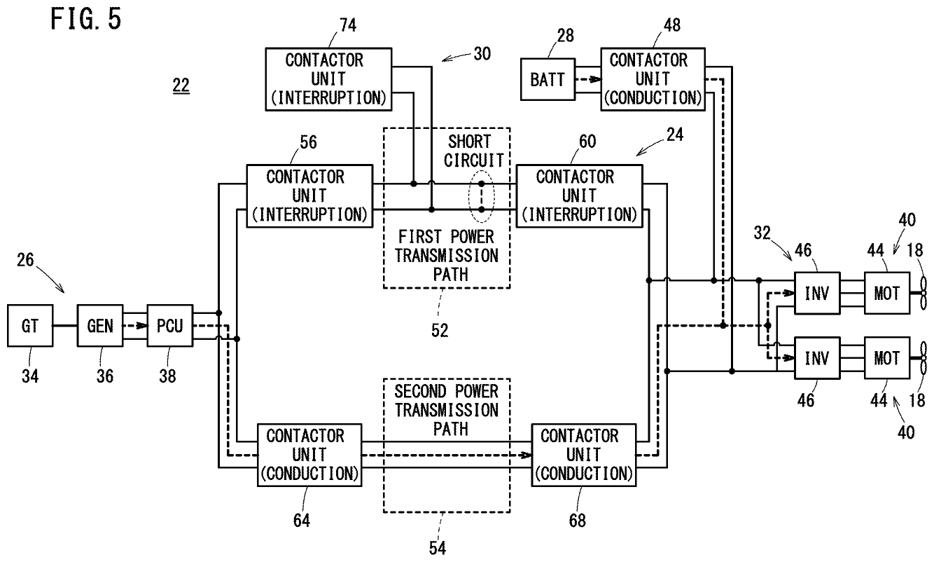

When the electric motor 44 is operated in a state in which the first power transmission path 52 has failed, the control unit 80 brings each of the contactor unit 48, the contactor unit 64, and the contactor unit 68 into the conduction state as shown in FIG. 5. Further, the control unit 80 brings each of the contactor unit 56, the contactor unit 60, and the contactor unit 74 into the interruption state. The case where the first power transmission path 52 fails is, for example, a case where the positive line and the negative line of the first power transmission path 52 are short-circuited. Further, the case where the first power transmission path 52 fails is, for example, a case where a part of the wiring of the first power transmission path 52 is disconnected. In this case, the charging device 72 is not connected to the charging circuit 30.

As a result, electric power is supplied from the generator 36 to each electric motor 44 via the second power transmission path 54. Further, electric power is supplied from the battery 28 to each electric motor 44. Each electric motor 44 is operated by the electric power supplied from the generator 36 and the battery 28, and each electric motor 44 drives each VTOL rotor 18.

(Case where Battery is Charged by Charging Device)

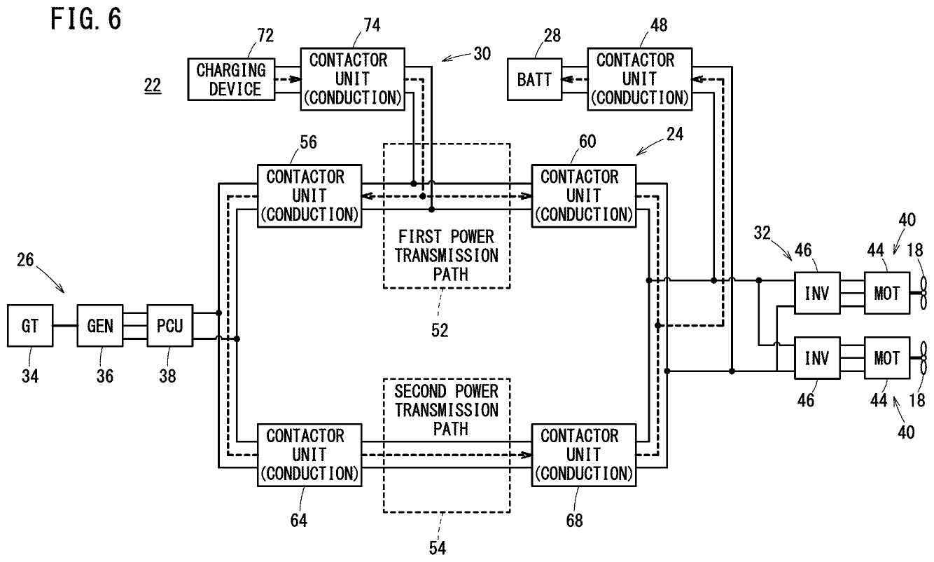

When the aircraft 10 is parked on the ground, the charging device 72 is connected to the charging circuit 30. The battery 28 is charged with electric power supplied from the charging device 72. When the battery 28 is charged by the charging device 72, the control unit 80 brings each of the contactor unit 48, the contactor unit 56, the contactor unit 60, the contactor unit 64, the contactor unit 68, and the contactor unit 74 into the conduction state as shown in FIG. 6.

As a result, electric power is supplied from the charging device 72 to the battery 28 via the first power transmission path 52, and electric power is supplied from the charging device 72 to the battery 28 via the second power transmission path 54. Thus, the battery 28 is charged with the electric power supplied from the charging device 72.

### [Advantageous Effects]

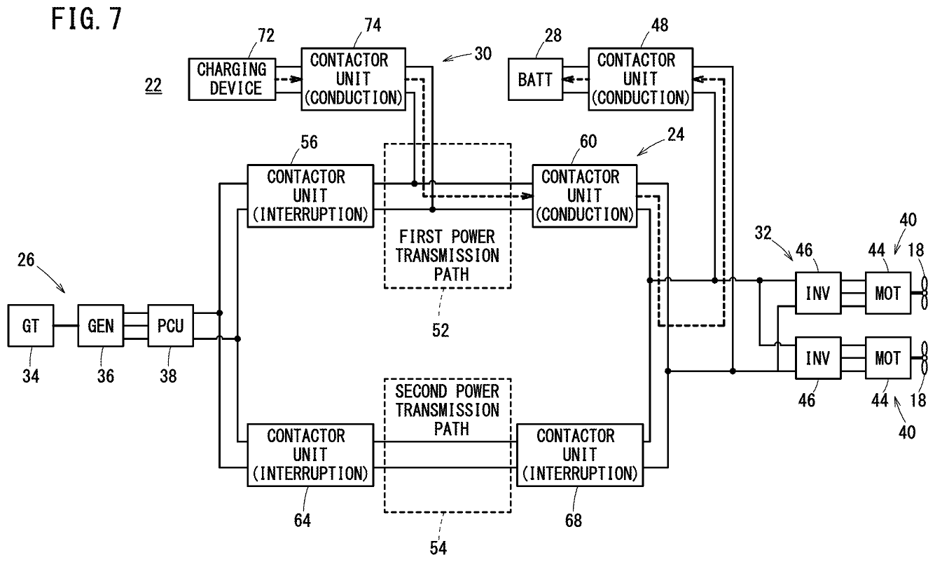

FIG. 7 is a schematic diagram of the power supply system 22. The operation of each contactor unit in a comparative example will be described with reference to FIG. 7.

In the comparative example, when the battery 28 is charged by the charging device 72, the control unit 80 brings each of the contactor unit 48, the contactor unit 60, and the contactor unit 74 into the conduction state. Further, the control unit 80 brings each of the contactor unit 56, the contactor unit 64, and the contactor unit 68 into the interruption state. As a result, electric power is supplied from the charging device 72 to the battery 28 via the first power transmission path 52.

When the battery 28 is charged by the charging device 72, both the first power transmission path 52 and the second power transmission path 54 are used in the power supply circuit 24 of the present embodiment, whereas only the first power transmission path 52 is used in the power supply circuit 24 of the comparative example.

Here, consideration will be given to heat generation amounts in the first power transmission path 52 and the second power transmission path 54 in a case where both the first power transmission path 52 and the second power transmission path 54 are used as in the present embodiment, and in a case where only the first power transmission path 52 is used as in the comparative example.

In the power supply system 22, the first power transmission path 52 and the second power transmission path 54 are cooled by a cooling device (not shown). This prevents the first power transmission path 52 or the second power transmission path 54 from failing due to heat. In order to reduce power consumption of the cooling device, it is necessary to reduce the heat generation amounts in the first power transmission path 52 and the second power transmission path 54.

The heat generation amount in each of the first power transmission path 52 and the second power transmission path 54 is substantially proportional to the square of the magnitude of the current flowing through each of the first power transmission path 52 and the second power transmission path 54. For example, it is assumed that, when the battery 28 is charged by the charging device 72, the magnitude of the current flowing through the first power transmission path 52 in the power supply circuit 24 of the comparative example is twice the magnitude of the current flowing through each of the first power transmission path 52 and the second power transmission path 54 in the power supply circuit 24 of the present embodiment.

In this case, the heat generation amount in the first power transmission path 52 in the power supply circuit 24 of the comparative example is about four times the heat generation amount in each of the first power transmission path 52 and the second power transmission path 54 in the power supply circuit 24 of the present embodiment. In the comparative example, since the second power transmission path 54 is not used, the power generation amount in the second power transmission path 54 is substantially 0.

That is, the sum of the heat generation amount in the first power transmission path 52 and the heat generation amount in the second power transmission path 54 in the power supply circuit 24 of the comparative example is about twice the sum of the heat generation amount in the first power transmission path 52 and the heat generation amount in the second power transmission path 54 in the power supply circuit 24 of the present embodiment.

Thus, according to the present embodiment, the sum of the heat generation amount in the first power transmission path 52 and the heat generation amount in the second power transmission path 54 can be reduced compared to the sum of the heat generation amount in the first power transmission path 52 and the heat generation amount in the second power transmission path 54 in the comparative example. Therefore, the power consumption of the cooling device in the present embodiment can be reduced compared to the power consumption of the cooling device in the comparative example.

In the present embodiment, when the battery 28 is charged by the charging device 72, both the first power transmission path 52 and the second power transmission path 54 are used. Therefore, there is a concern that both the first power transmission path 52 and the second power transmission path 54 may fail at the same time. However, when the battery 28 is charged by the charging device 72, the aircraft 10 is parked. Therefore, even when both the first power transmission path 52 and the second power transmission path 54 fail at the same time, there is no influence on the flight of the aircraft 10.

In the present embodiment, when each electric motor 44 is operated, the power supply system 22 supplies electric power from the generator 36 to each electric motor 44 via the first power transmission path 52. Accordingly, it is possible to prevent the second power transmission path 54 from failing during the flight of the aircraft 10.

In the present embodiment, when the first power transmission path 52 fails, the power supply system 22 supplies electric power from the generator 36 to each electric motor 44 via the second power transmission path 54. Accordingly, even when the first power transmission path 52 fails, the flight of the aircraft 10 can be continued.

### Second Embodiment

The aircraft 10 of the first embodiment includes the generator and the battery as power sources of the electric motor. On the other hand, the aircraft 10 of the present embodiment includes only the battery as the power source of the electric motor.

The power supply system 22 of the aircraft 10 of the first embodiment includes the power generation unit 26. On the other hand, the power supply system 22 of the aircraft 10 of the present embodiment includes a battery 82 instead of the power generation unit 26. Further, in the power supply system 22 of the aircraft 10 of the first embodiment, the battery 28 is connected to each drive module 32. On the other hand, in the power supply system 22 of the aircraft 10 of the present embodiment, the battery 28 is not connected to each drive module 32. Each contactor unit is controlled by the control unit 80 as in the first embodiment.

### [Operation of Contactor Unit]

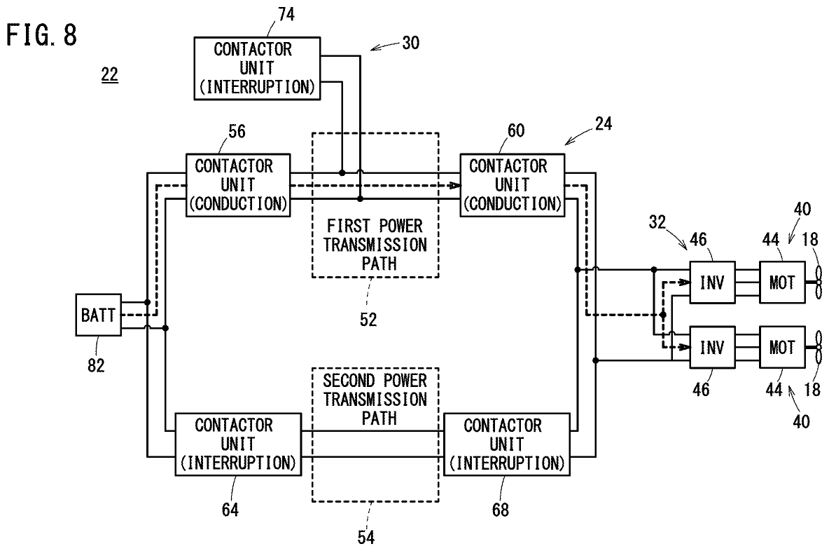

FIGS. 8 to 10 are schematic diagrams of the power supply system 22. FIGS. 8 to 10 schematically show the circuit configuration of the power supply circuit 24 between one battery 82 and one drive module 32. Hereinafter, the operation of each contactor unit will be described with reference to FIGS. 8 to 10. In the case where the number of the batteries 82 is two or more and the number of the drive modules 32 is two or more, although the number of the contactor units is increased, the operation of each contactor unit is the same as the operation described below.

(Case where Electric Motor is Operated)

When the electric motor 44 is operated, the control unit 80 brings each of the contactor unit 56 and the contactor unit 60 into the conduction state as shown in FIG. 8. Further, the control unit 80 brings each of the contactor unit 64, the contactor unit 68, and the contactor unit 74 into the interruption state. In this case, the charging device 72 is not connected to the charging circuit 30.

Thus, electric power is supplied from the battery 82 to each electric motor 44 via the first power transmission path 52. Each electric motor 44 is operated by the electric power supplied from the battery 82, and each electric motor 44 drives each VTOL rotor 18.

(Case where First Power Transmission Path Fails)

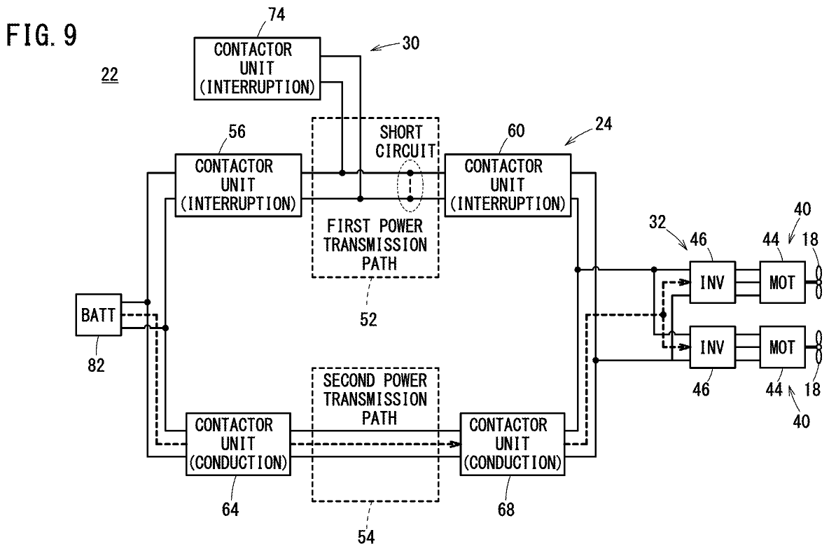

When the electric motor 44 is operated in a state in which the first power transmission path 52 has failed, the control unit 80 brings each of the contactor unit 64 and the contactor unit 68 into the conduction state as shown in FIG. 9. Further, the control unit 80 brings each of the contactor unit 56, the contactor unit 60, and the contactor unit 74 into the interruption state. In this case, the charging device 72 is not connected to the charging circuit 30.

As a result, electric power is supplied from the battery 82 to each electric motor 44 via the second power transmission path 54. Each electric motor 44 is operated by the electric power supplied from the battery 82, and each electric motor 44 drives each VTOL rotor 18.

(Case where Battery is Charged by Charging Device)

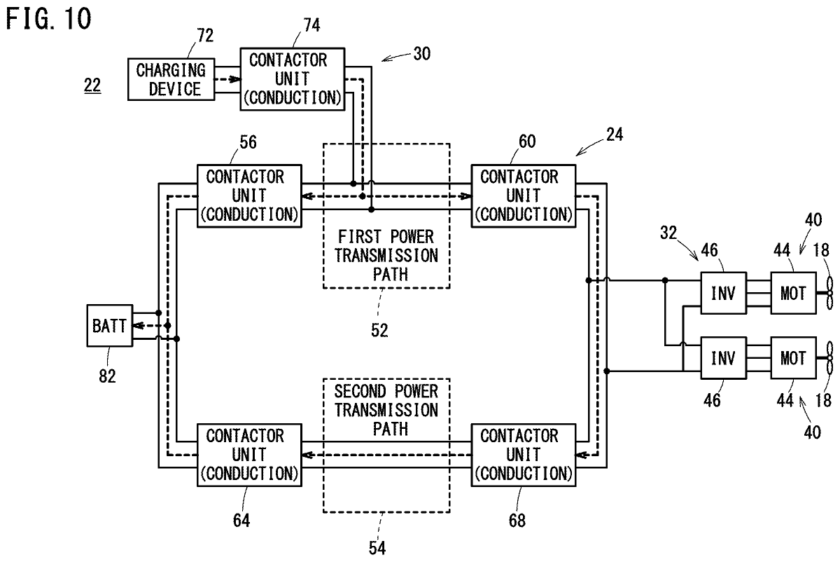

When the aircraft 10 is parked on the ground, the charging device 72 is connected to the charging circuit 30. The battery 82 is charged by the charging device 72. When the battery 82 is charged by the charging device 72, the control unit 80 brings each of the contactor unit 56, the contactor unit 60, the contactor unit 64, the contactor unit 68, and the contactor unit 74 into the conduction state as shown in FIG. 10.

Accordingly, electric power is supplied from the charging device 72 to the battery 82 via the first power transmission path 52, and electric power is supplied from the charging device 72 to the battery 82 via the second power transmission path 54. Thus, the battery 82 is charged with the electric power supplied from the charging device 72.

### Advantageous Effects

In the power supply system 22 of the present embodiment, when the battery 82 is charged, both the first power transmission path 52 and the second power transmission path 54 are used. This makes it possible to reduce the heat generation amounts in both the first power transmission path 52 and the second power transmission path 54. Therefore, the power consumption of the cooling device in the present embodiment can be reduced compared to the power consumption of the cooling device in the comparative example.

In the present embodiment, when each electric motor 44 is operated, the power supply system 22 supplies electric power from the battery 82 to each electric motor 44 via the first power transmission path 52. Accordingly, it is possible to prevent the second power transmission path 54 from failing during the flight of the aircraft 10.

In the present embodiment, when the first power transmission path 52 fails, the power supply system 22 supplies electric power from the battery 82 to each electric motor 44 via the second power transmission path 54. Accordingly, even when the first power transmission path 52 fails, the flight of the aircraft 10 can be continued.

Note that the present invention is not limited to the above disclosure, and various modifications are possible without departing from the essence and gist of the present invention.

In the first embodiment, the power supply system 22 includes two power generation units 26. The power supply system 22 may include one or more power generation units 26.

In the first embodiment, the power supply system 22 supplies electric power to six drive modules 32. The power supply system 22 may be capable of supplying electric power to one or more drive modules 32.

### Invention Obtained from Embodiments

The invention that can be grasped from the above embodiments will be described below.

The power supply circuit (24) of the aircraft (10) includes: the first power transmission path (52) configured to supply electric power to at least one load device (32); the second power transmission path (54) provided in parallel with the first transmission path and configured to supply electric power to the at least one load device; and the third power transmission path (30) connected to the first power transmission path and configured to supply electric power from the charging device (72) provided outside the aircraft to the first power transmission path, wherein at least one battery (28, 82) is connected to both the first power transmission path and the second power transmission path, and when the at least one battery is charged with electric power supplied from the charging device, the electric power is supplied from the charging device to the battery via the first power transmission path, and the electric power is supplied from the charging device to the battery via the second power transmission path. According to this feature, it is possible to suppress power consumption of the cooling device that cools the electric circuit.

In the above-described power supply circuit of the aircraft, the first power transmission path may be configured to supply electric power from at least one power source device (26) to the at least one load device, the second power transmission path may be configured to supply electric power from the at least one power source device to the at least one load device, and when the at least one load device is operated by the electric power supplied from the at least one power source device, the electric power may be supplied from the power source device to the load device via the first power transmission path, the flow of current between the second power transmission path and the power source device may be interrupted, and the flow of current between the second power transmission path and the load device may be interrupted. According to this feature, it is possible to prevent the second power transmission path from failing during the flight of the aircraft.

In the above-described power supply circuit of the aircraft, even when the at least one load device is operated by the electric power supplied from the at least one power source device, if the first power transmission path has failed, the electric power may be supplied from the power source device to the load device via the second power transmission path, the flow of current between the first power transmission path and the power source device may be interrupted, and the flow of current between the first power transmission path and the load device may be interrupted. According to this feature, even when the first power transmission path has failed, the aircraft can continue flying.

In the above-described power supply circuit of the aircraft, the first power transmission path may be configured to supply electric power from the at least one battery to the at least one load device, the second power transmission path may be configured to supply electric power from the at least one battery to the at least one load device, and when the at least one load device is operated by the electric power supplied from the at least one battery, the electric power may be supplied from the battery to the load device via the first power transmission path, the flow of current between the second power transmission path and the battery may be interrupted, and the flow of current between the second power transmission path and the load device may be interrupted. According to this feature, it is possible to prevent the second power transmission path from failing during the flight of the aircraft.

In the above-described power supply circuit of the aircraft, even when the at least one load device is operated by the electric power supplied from the at least one battery, if the first power transmission path has failed, the electric power may be supplied from the battery to the load device via the second power transmission path, the flow of current between the first power transmission path and the battery may be interrupted, and the flow of current between the first power transmission path and the load device may be interrupted. According to this feature, even when the first power transmission path has failed, the aircraft can continue flying.

1. A power supply circuit of an aircraft, the power supply circuit comprising:
a first power transmission path configured to supply electric power to at least one load device;
a second power transmission path provided in parallel with the first power transmission path, and configured to supply electric power to the at least one load device; and
a third power transmission path connected to the first power transmission path, and configured to supply electric power from a charging device provided outside the aircraft to the first power transmission path,
wherein at least one battery is connected to both the first power transmission path and the second power transmission path, and
when the at least one battery is charged with the electric power supplied from the charging device, the electric power is supplied from the charging device to the battery via the first power transmission path, and the electric power is supplied from the charging device to the battery via the second power transmission path.

2. The power supply circuit of the aircraft according to claim 1, wherein
the first power transmission path is configured to supply electric power from at least one power source device to the at least one load device,
the second power transmission path is configured to supply electric power from the at least one power source device to the at least one load device, and
when the at least one load device is operated by the electric power supplied from the at least one power source device, the electric power is supplied from the power source device to the load device via the first power transmission path, flow of current between the second power transmission path and the power source device is interrupted, and flow of current between the second power transmission path and the load device is interrupted.

3. The power supply circuit of the aircraft according to claim 2, wherein
even when the at least one load device is operated by the electric power supplied from the at least one power source device, if the first power transmission path has failed, the electric power is supplied from the power source device to the load device via the second power transmission path, flow of current between the first power transmission path and the power source device is interrupted, and flow of current between the first power transmission path and the load device is interrupted.

4. The power supply circuit of the aircraft according to claim 1, wherein
the first power transmission path is configured to supply electric power from the at least one battery to the at least one load device,
the second power transmission path is configured to supply electric power from the at least one battery to the at least one load device, and
when the at least one load device is operated by the electric power supplied from the at least one battery, the electric power is supplied from the battery to the load device via the first power transmission path, flow of current between the second power transmission path and the battery is interrupted, and flow of current between the second power transmission path and the load device is interrupted.

5. The power supply circuit of the aircraft according to claim 4, wherein
even when the at least one load device is operated by the electric power supplied from the at least one battery, if the first power transmission path has failed, the electric power is supplied from the battery to the load device via the second power transmission path, flow of current between the first power transmission path and the battery is interrupted, and flow of current between the first power transmission path and the load device is interrupted.
